(19) United States
(12) Patent Application Publication
(10) Pub. No.: US 2010/0140355 A1
(43) Pub. Date: Jun. 10, 2010

(54) Systems and methods for aiding data organization related applications

(76) Inventor: Blake A. Egan, Kenosha, WI (US)

Correspondence Address: RYAN KROMHOLZ & MANION, S.C., POST OFFICE BOX 26618, MILWAUKEE, WI, 53226, US

(21) Appl. No.: 12/592,588

(22) Filed: Nov. 30, 2009

Related U.S. Application Data
(60) Provisional application No. 61/200,569, filed on Dec. 1, 2008.

(51) Int. Cl. G06F 17/30; G06K 7/10

(52) U.S. Cl. 235/462.01; 707/805; 235/470; 707/E17.005

(57) ABSTRACT

Presented are systems and methods for aiding data organization. Generally, the system includes an electronic signal processor that receives electronic signals from user input devices, such as a computer keyboard and/or bar code scanner, and that transmits electronic signals to user output devices, such as a visual display human machine interface and/or a label printer. Once a certain input, such as an electronic signal representing a scanned optical code, is received by the processor, the processor prioritizes the appropriate graphical user interface on the visual display to allow for data entry by a user of the system. Data entry prompts and responses to user input are at least partially customizable by a user.

### RELATED APPLICATIONS

This application claims the benefit of co-pending provisional patent application Ser. No. 61/200,569, filed 1 Dec. 2008.

### BACKGROUND OF THE INVENTION

The present invention relates generally to the field of data organization, and more specifically to systems and methods for the prioritization of data entry user interfaces on a computing device and the customization of data entry prompts or fields to be displayed on the prioritized user interface.

The management of data, student educational grading data, for example, can be an arduous task. Many of those responsible for such management, e.g., teachers, cannot control and manage the exchange and grading of educational homework assignments without spending extensive amounts of time.

### SUMMARY OF THE INVENTION

An embodiment of a method according to the present invention includes the step of receiving a scan code at an electronic processing device, where the scan code comprises a representation of a scanned optical code, such as an optical bar code. The code may be received from an optical code scanner, such as a bar code scanner, for example. The electronic processing device may include a laptop computer. The embodiment further includes the step of prioritizing a software application graphical user interface on a graphical human machine interface, where the graphical human machine interface is in communication with the electronic processing device. The prioritizing step preferably occurs after and in direct response to the receiving step. The embodiment also includes the step of accessing a database, where the database has at least one entry associating the optical code with an entity. The database preferably resides in nonvolatile electronic memory that is included in or accessible by the electronic processing device. The entity may be a business organization, such as a corporation, or a person, such as a student or medical patient. The embodiment further includes the steps of displaying a prompt, which may be changeable or customizable, for data entry in the software application graphical user interface and receiving entered data comprising a representation of association data, the association data comprising at least one data string to be associated with the optical code in the database. The association data may be coextensive with the entered data. The embodiment also includes the step of associating said association data with a representation of said optical code in said database. The associating step may comprise the step of creating a new record, or modifying an existing record, in the database.

A method according to the present invention may further comprise the step of executing the software application prior to the prioritizing step. The executing step may occur after and in direct response to the receiving step.

A method according to the present invention may further comprise the step of generating the association data in response to said entered data.

Another embodiment of a method according to the present invention includes the steps of scanning an optical code with an optical code scanner, the optical code scanner being in electronic communication with an electronic processing device; and, in response to a data entry prompt displayed in a prioritized, active data entry graphical user interface module, entering a customized response through a user input device, the customized response to be associated with the optical code. The electronic processing device may comprise a central processing unit of a personal computer. The entering step may include the step of depressing at least one key on an electronic keyboard, which may be in communication with the electronic processing device. Alternatively or additionally, the entering step may include depressing a button on a computer mouse that is in communication with the electronic processing device.

### BRIEF DESCRIPTION OF THE DRAWINGS

FIG. 1 provides a diagram view of a system according to the present invention.

FIG. 2A provides a flow chart for a prior art method for organizing data related to an educational homework assignment.

FIG. 2B provides a flow chart for a method according to the present invention for organizing data related to an educational homework assignment.

FIG. 3A is a visual or graphical human machine interface display including no active graphical user interface (GUI) modules.

FIG. 3B is the visual human machine interface display of FIG. 3A, further including a prioritized active data entry GUI module.

FIG. 4A is the visual human machine interface display of FIG. 3A, further including a first active GUI module.

FIG. 4B is the visual human machine interface display of FIG. 4A, further including a prioritized active data entry GUI module.

FIG. 5A is the visual, human machine interface display of FIG. 3A, further including a first, active GUI module and a second, inactive data entry GUI module.

FIG. 5B is the visual human machine interface display of FIG. 5A, wherein the second GUI module has been prioritized and activated, and the first GUI module has been deactivated.

FIG. 6A is the visual human machine interface display of FIG. 3A, further including a first, active GUI module and a second, inactive background GUI module.

FIG. 6B is the graphical human machine interface display of FIG. 6A, wherein the second GUI module has been prioritized and activated, and the first GUI module has been deactivated, and may be minimized.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

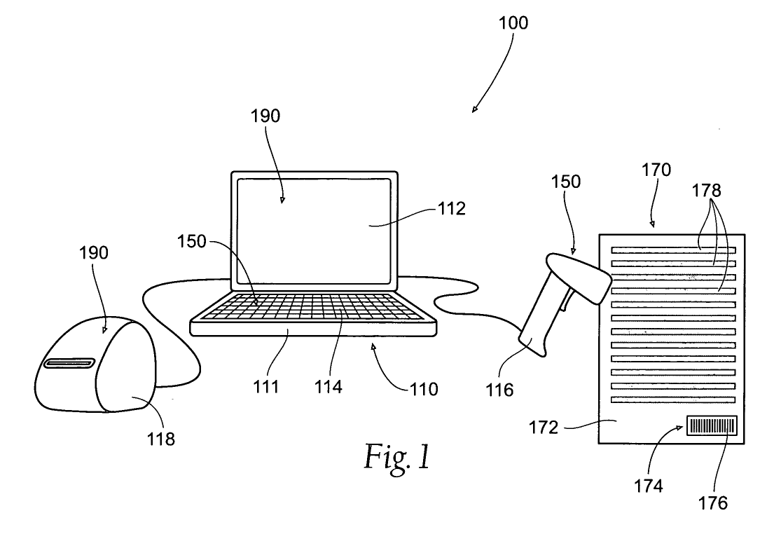

FIG. 1 depicts a system 100 according to the present invention. The system 100 includes an electronic processing device 110, such as a computer 111, a plurality of user input devices 150, and a reference object 170. Generally, the electronic processing device 110 includes an electronic signal processor (not shown), such as a microprocessor, that is capable of directly or indirectly receiving input from the user input devices 150, and also capable of directly or indirectly controlling output to user output devices 190. Examples of user input devices 150 may be a computer keyboard 114, a computer mouse (not shown), a bar code scanner 116, and a microphone (not shown). A preferred bar code scanner 116 is a Symbol LS2208 handheld bar code scanner, available from Motorola, Inc. Examples of user output devices 190 may be a visual human machine interface, such as a liquid crystal display (LCD) 112 of a laptop computer, and a printer, such as a label printer 118. A preferred label printer 118 is a LabelWriter 400 Turbo, sold under the brand name DYMO®. The user input devices 150 and the user output devices 190 may be integrally housed in the same housing as the electronic microprocessor, or they may be provided separately and electrically coupled to the computer by way of a plug/jack interface, such as by a Universal Serial Bus (USB) plug/jack interface.

The reference object 170 may be anything that has an optical code 174 associated with it, such as being adhered to it. For example, the object 170 may be a sheet of paper 172, such as an answer sheet to an educational homework assignment, with a plurality of markings 178, such as handwritten or type written symbols, on it. The optical code 174 may be, for example, a bar code 176 to be scanned by the bar code scanner 116. The optical code 174 may also consist of the markings 178 on the paper 172, themselves, to be scanned by an optical character recognition (OCR) device. The label printer 118 may be used to print adhesive bar code labels to adhere directly to a reference object 170, or the reference object 170 may be printed on directly.

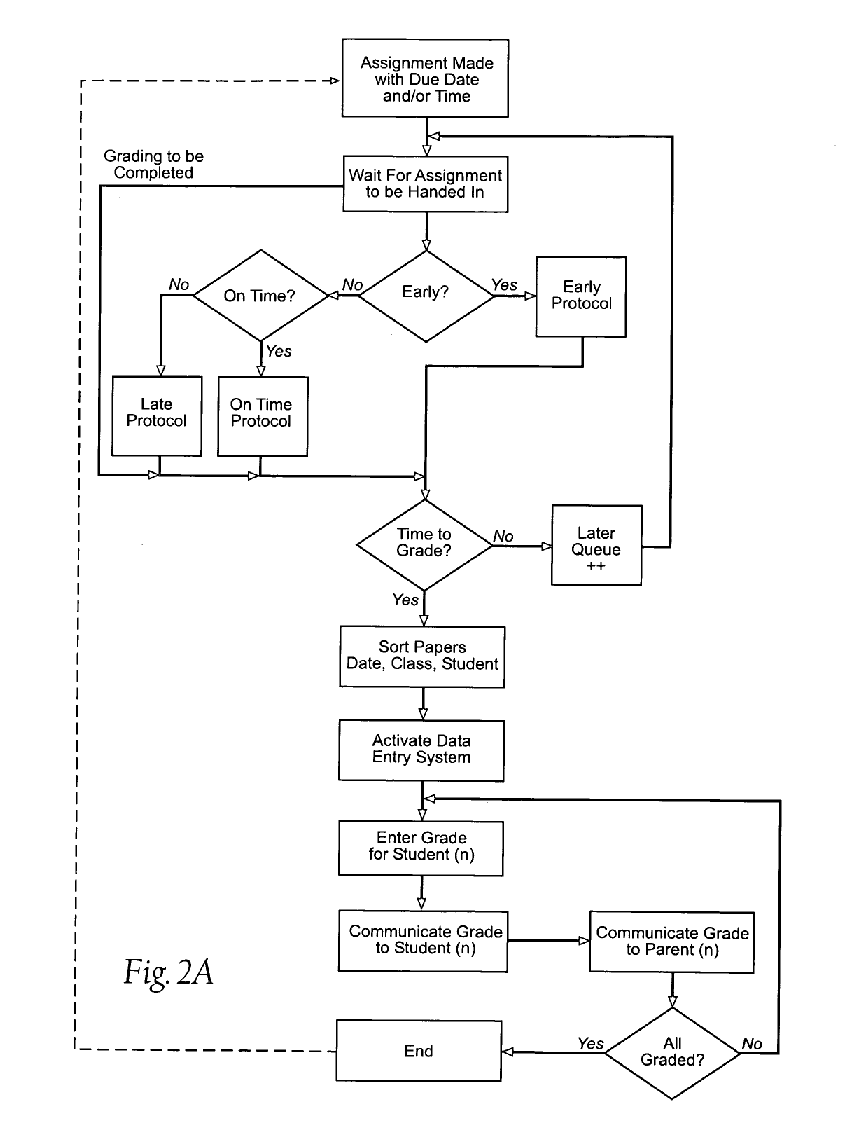

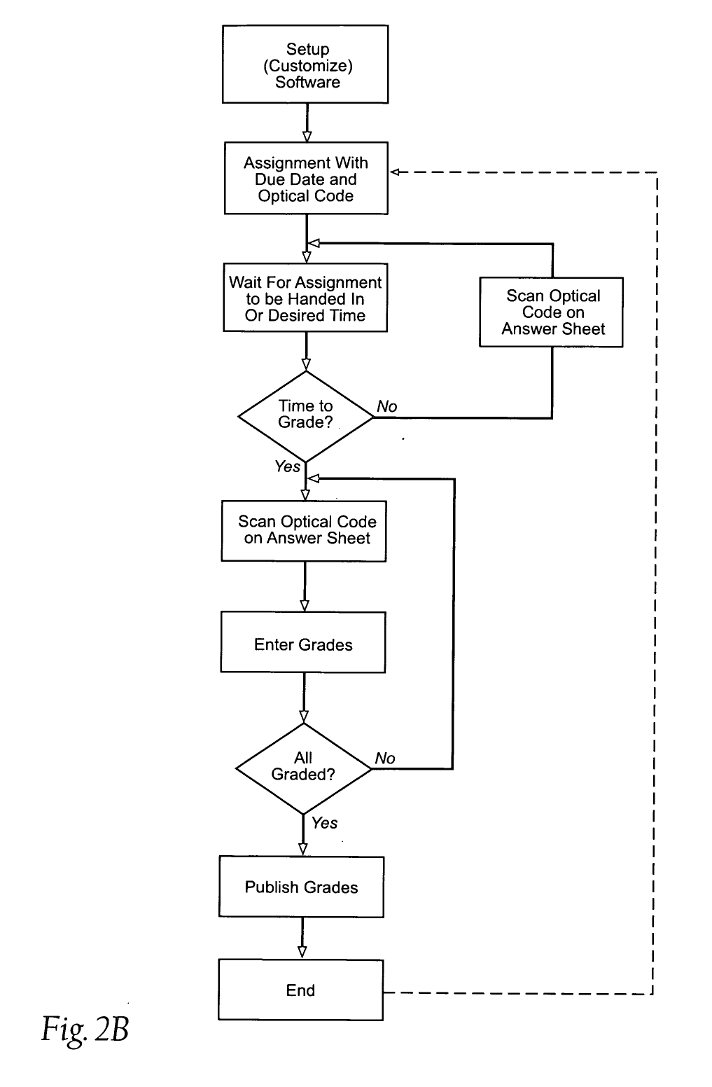

FIG. 2A depicts a prior method of grading papers. An assignment is made by an educational instructor, and students are informed that the assignment has a certain due date and/or time. The return of answer sheets to the instructor is then largely out of the instructor's control. Answer sheets may be turned in early, on time, or late, and the instructor may have a desired grading protocol associated with each time frame. The instructor also may be in the middle of doing something else on the instructor's computer when an assignment is turned in. Thus, after the assignment is made, the instructor waits for an assignment to be handed in. The instructor then must determine whether the assignment was early, on time, or late, and then the grading protocol for each time frame is followed. More than likely, an instructor will not grade homework answer sheets as they trickle in from students, but will rather wait until at least the due date, and will then grade a plurality of answer sheets serially. When it is time to grade the answer sheets, the instructor manually sorts answer sheets into different categories, such as assignment number, class indicator, and/or student name. If the instructor is using a data entry system, such as a spreadsheet, the system is activated, and grades are entered for each individual student. If desired, the instructor may communicate the grades to the students and/or their parents. The data acquisition and tracking process of prior grading systems was thus quite laborious.

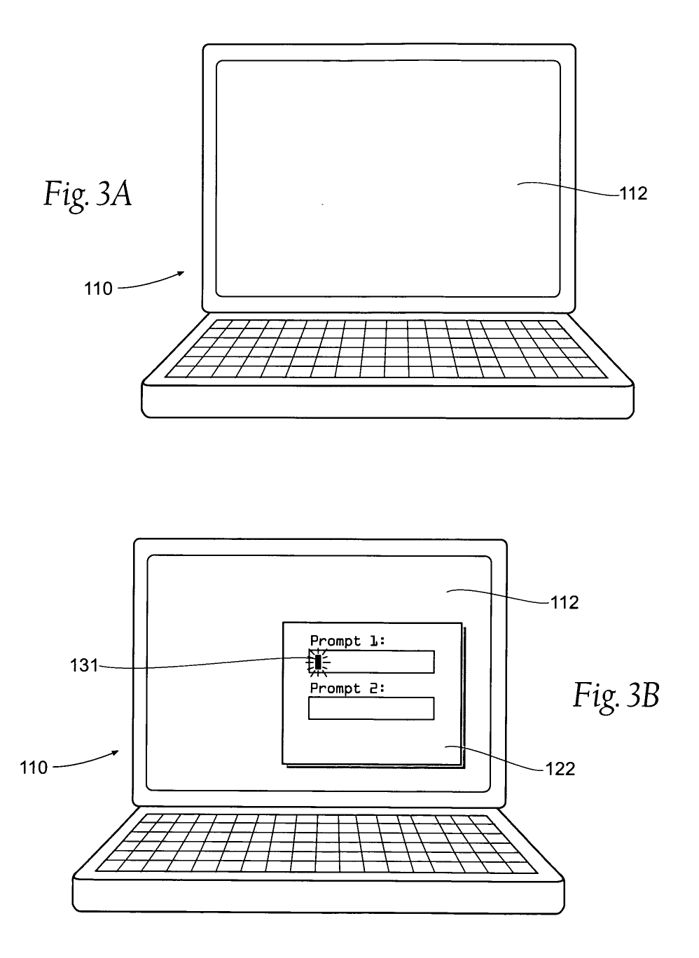

FIG. 2B presents a method according to the present invention. First, a customization process, or set-up process, is executed to customize the data entry interaction between the system 100, and an educational instructor. This customization process may be executed a single time, or it may be executed whenever the instructor/user wishes to change parameters. In this set-up process, the user is presented with optional questions, and is able to determine whether the question is desired, and if so, what the data entry response of the software will be. Attached pages related to skeleton sheets generally discuss customizing data entry flow, prompts, and user input. As in the prior method, an instructor assigns an educational homework assignment having a due date and/or time. Again, the time at which assignments are handed in by students is largely out of the instructor's control. The assignment answer sheets are to be similar to those sheets 172, discussed above. That is, an assignment sheet 172 provides an optical code 174, preferably a bar code 176. When an answer sheet 172 is received, the instructor may scan the bar code 176, which immediately prioritizes a data entry graphical user interface, as described further in connection with FIGS. 3A-6B. In the background, the software application accesses a database that has at least one entry associating the optical code with an entity, such as a student. If the instructor wishes to enter various data at that time, the instructor may do so, or the instructor may wait until a later time. In any event, the system 100 logs the turn-in time of the answer sheet. When it is time to grade any and all answer sheets 172 that the instructor has, the instructor merely scans a sheet 172 and replies to the customized data entry prompts. In a single step, grades can be published to, or accessible through, an Internet website having secure, password-protected access, and/or may be sent via an e-mail to each or all graded students and their parents. The system and method according to the present invention eliminates all need for sorting and alphabetizing papers prior to grading and allows a customizable data entry interface.

FIGS. 3A and 3B depict a first prioritization scheme that may be achieved by the present invention. Generally, the processing device 110 of the present invention will be active and powered on, and a visual human machine interface or graphical user interface, such as an LCD screen 112, will be displayed. The processor will have access to software applications, generally loaded into random access memory (RAM) accessible by or included in the processing device 110. Shown in FIG. 3A, there may be no graphical user interface (GUI) module displayed on the LCD 112. Generally, a GUI module may be represented by a “window” on a display for a computer that is executing Microsoft® Windows® software. FIG. 3B depicts the display after a scan of an optical code 174 by a user of the system 100. After an optical code 174, such as a bar code 176, is scanned by a user input device 150, such as a bar code scanner 116, a data entry GUI module 122 will be prioritized. For purposes of this application, the term “prioritized” indicates a superimposition of a GUI module over all other visual displays on the human machine interface, if any, and activation of that GUI module to allow direct data entry therein, as symbolized in the figures by a blinking cursor 131. A similar function that is provided in the Windows® operating system software is the “Restore” function, which prioritizes a GUI module for a software application that may be open, but may not be superimposed nor activated.

One method of controlling the superimposition and activation of a data entry GUI module is through the use of ActiveWords®, a software macro program that allows a user to assign particularized functionality based on user input. ActiveWords® software is purportedly covered by U.S. Pat. No. 5,974,413 and U.S. Pat. No. 6,438,545, both of which are incorporated herein by reference in their respective entirety. As such, the computer 111 that is running ActiveWords® software in the background will recognize when an optical code 174 is scanned, and the data entry GUI module 122 will be prioritized and activated. The activation of the GUI module 122 may further include the process of executing a database interface software application, if the application is not already running, or loaded into RAM.

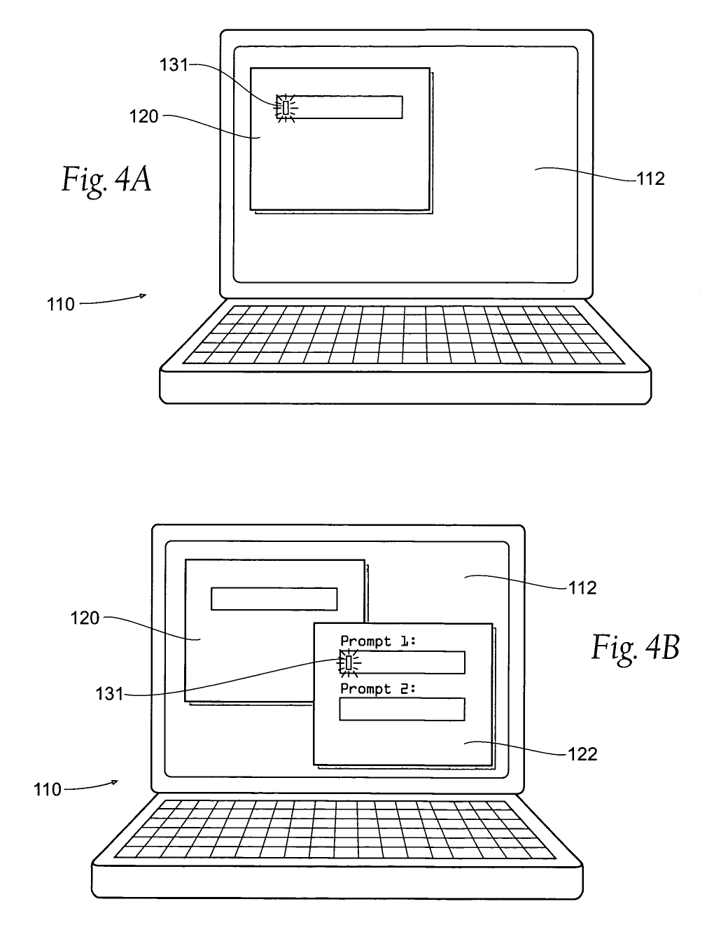

FIG. 4A shows a first GUI module 120 that may be activated, such as an Internet web browser that a user of the computer 111 is utilizing. FIG. 4B depicts the display 112 after a scan of an optical code 174 by a user of the system 100. After an optical code 174, such as a bar code 176, is scanned by a user input device 150, such as a bar code scanner 116, a data entry GUI module 122 will be prioritized over the web browser GUI 120, simply by virtue of the optical code scan.

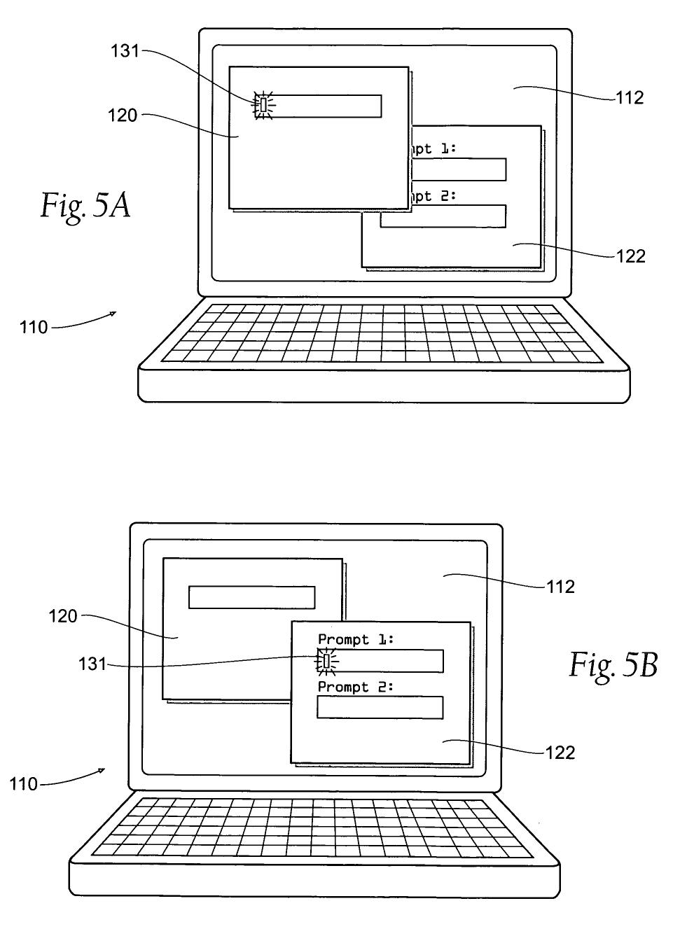

FIG. 5A shows a first GUI module 120 that may be prioritized over a second data entry GUI module 122, and activated, such as an Internet web browser that a user of the computer 111 is utilizing. FIG. 5B depicts the display 112 after a scan of an optical code 174 by a user of the system 100. After an optical code 174, such as a bar code 176, is scanned by a user input device 150, such as a bar code scanner 116, the second data entry GUI module 122 will be prioritized over the web browser GUI 120, simply by virtue of the optical code scan.

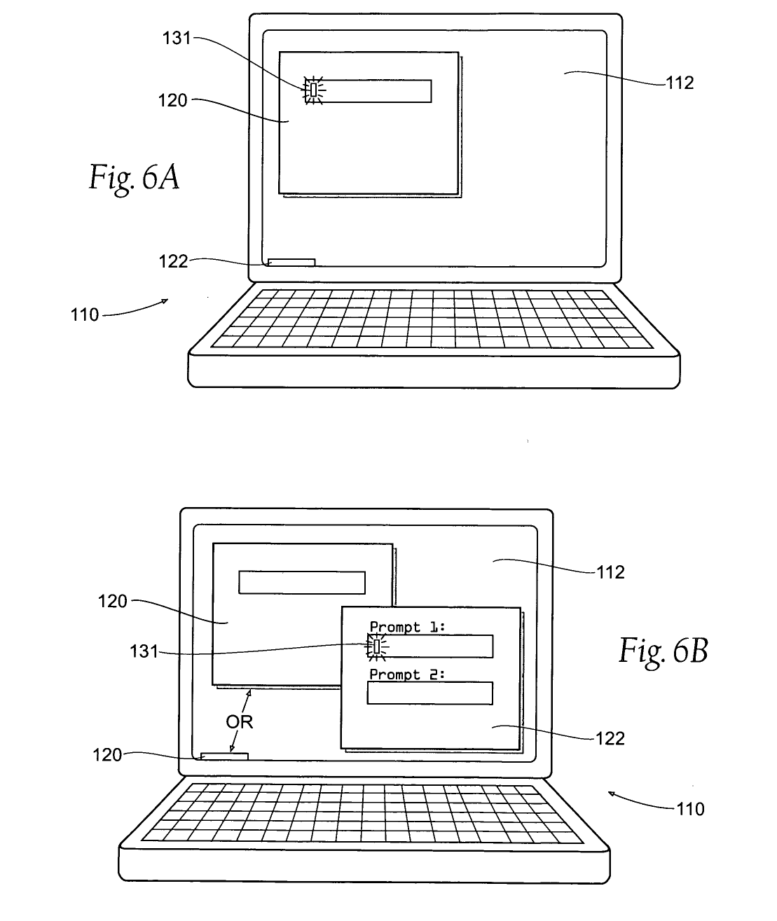

FIG. 6A shows a first GUI module 120 that may be prioritized over a minimized second data entry GUI module 122, and activated, such as an Internet web browser that a user of the computer 111 is utilizing. FIG. 6B depicts the display 112 after a scan of an optical code 174 by a user of the system 100. After an optical code 174, such as a bar code 176, is scanned by a user input device 150, such as a bar code scanner 116, the second data entry GUI module 122 will be prioritized over the web browser GUI 120, simply by virtue of the optical code scan. Alternatively, instead of simple prioritization, the first GUI module 120 may be minimized, in addition to being deprioritized.

The foregoing is considered as illustrative only of the principles of the invention. Furthermore, since numerous modifications and changes will readily occur to those skilled in the art, it is not desired to limit the invention to the exact construction and operation shown and described. For instance, while the preferred embodiment includes a description of a database containing grading records for an educator or his or her assistant, various types of information or data may be housed in a similar database, such as medical patient data, engineering test data, and various business information. While the preferred embodiment has been described, the details may be changed without departing from the invention, which is defined by the claims.

I claim:

1. A method comprising the steps of:
a. receiving a scan code at an electronic processing device, said scan code comprising a representation of a scanned optical code;
b. prioritizing a software application graphical user interface on a graphical human machine interface, said graphical human machine interface in communication with said electronic processing device;
c. accessing a database, said database having at least one entry associating said optical code with an entity;
d. displaying a prompt for data entry in said software application graphical user interface;
e. receiving entered data comprising a representation of association data, said association data comprising at least one data string to be associated with said optical code in said database; and,
f. associating said association data with a representation of said optical code in said database.

2. A method according to claim 1, said scan code received from an optical code scanner.

3. A method according to claim 1, said prioritizing step occurring after said receiving step.

4. A method according to claim 3, said prioritizing step occurring in response to said receiving step.

5. A method according to claim 1, further comprising the step of executing said software application prior to said prioritizing step.

6. A method according to claim 5, said executing step occurring after said receiving step.

7. A method according to claim 6, said executing step occurring in response to said receiving step.

8. A method according to claim 1, further comprising the step of generating said association data in response to said entered data.

9. A method according to claim 1, wherein said association data is said entered data.

10. A method according to claim 1, said associating step comprising the step of creating a new record in said database.

11. A method according to claim 1, said saving step comprising the step of modifying an existing record in said database.

12. A method according to claim 1, said optical code comprising an optical bar code and said optical code scanner comprising an optical bar code scanner.

13. A method according to claim 1, said entity comprising a person.

14. A method according to claim 1, said entity comprising a business organization.

15. A method according to claim 1, said database having a structure residing in nonvolatile electronic memory included in said electronic processing device.

16. A method according to claim 1, said software application graphical user interface providing means for modifying said prompt.

17. A method comprising the steps of:
a. scanning an optical code with an optical code scanner, said optical code scanner being in electronic communication with an electronic processing device; and,
b. in response to a data entry prompt displayed in a prioritized, active data entry graphical user interface module, entering a customized response through a user input device, the customized response to be associated with said optical code.

18. A method according to claim 17, said electronic processing device comprising central processing unit of a personal computer.

19. A method according to claim 17, said entering step comprises depressing at least one key on an electronic keyboard.

20. A method according to claim 17, said entering step comprises depressing a button on a computer mouse.
